(19) United States
(12) Patent Application Publication
(10) Pub. No.: US 2006/0007300 A1
(43) Pub. Date: Jan. 12, 2006

(54) Method of obtaining a succession of images in the form of a circling effect

(76) Inventors: Oliver Gafsou, Issy-Les-Moulineaux (FR); Matthieu Skrzypniak, Chatillon (FR); Serge Dulin, Nanteau Sur Lunain (FR); Jean Lecharny, Viroflay (FR)

Correspondence Address: STITES & HARBISON PLLC, 1199 NORTH FAIRFAX STREET, SUITE 900, ALEXANDRIA, VA, 22314, US

(21) Appl. No.: 11/175,047

(22) Filed: Jul. 6, 2005

(30) Foreign Application Priority Data
Jul. 7, 2004 (FR) 0407542

(51) Int. Cl. H04N 7/00

(52) U.S. Cl. 348/38

(57) ABSTRACT

The subject of the invention is a succession of images in the form of a sequence representing a circling effect substantially around an object of interest (OI). A plurality of l video cameras (CAM1-CAM16) fixed in position and in adjustment are provided to capture, in wide field but at different respective shot angles, a fixed scene, in which the object of interest moves. Different images acquired by the video cameras are gatherered. After the acquired images are readjusted amongst themselves thanks to predetermined markers in the image, a sequence is constructed by concatenation of the acquired images with an order of images in the sequence corresponding to an order of positions of the video cameras along a line.

The present invention relates to the field of the processing of images acquired by video cameras and intended mainly for a television broadcast.

Through certain cinematographic representations, a visual effect, hereinafter called “circling effect”, is known in which the point from which the shot is taken appears to circle around an object of interest, such as an individual jumping in the air.

To obtain this effect, several video cameras, or else stills cameras, are provided typically arranged in a circle or an arc of a circle around the object of interest. The opening of the stills cameras or the beginning of acquisition of images of the video cameras is initiated substantially instantaneously. Several images are then obtained originating respectively from the stills cameras or the video cameras, from several shot angles. A film sequence is constructed in which each image is one of the images acquired respectively by the stills cameras or the video cameras. These images are concatenated, in the film, in an order which corresponds to an order of respective positions of the stills cameras or video cameras on the aforementioned arc of a circle or circle. The film corresponding to this sequence of images then represents a visual effect by which an observer has the sensation of circling around the object of interest.

A method of this type is known particularly through document US-2003/0133018. In this document, several stills cameras are arranged around an object of interest, which is substantially immobile. More particularly, the initiation of the shot of one of the stills cameras, called the “master”, also initiates the shots of the other stills cameras, called “slaves”. For this purpose, the slave stills cameras comprise a light sensor to detect the flash that the initiation of the master stills camera causes.

The visual effect corresponding to this circling effect has proved to be of great value particularly for the retransmission of sporting events. For example, for a live television retransmission of a football match, it has proved useful to obtain several shot angles of one and the same game action, particularly when one of the players handled the ball in the penalty area. In this case, a sequence representing a circling effect around the player, transmitted with a slight time delay, would allow the televiewers to measure the intention of the player to commit this offence.

However, this application of the circling effect to the retransmission of sporting events has technical implementation difficulties due in particular to the fact that the aforementioned “objects of interest” are typically sportsmen or racing vehicles that are in motion.

A solution that could be envisaged to remedy this problem is to provide several video cameras, including one “master” video camera which follows the movements of an object of interest and “slave” video cameras which follow the adjustments in focus, zoom, position, pan, and tilt of the master video camera by servo-control.

However, this solution seems cumbersome to implement, due in particular to all the instrumentation necessary for the transmission of the adjustment data from the master video camera to the slave video cameras. It is also necessary initially to calibrate the adjustments of all the video cameras.

The present invention comes to improve the situation.

For this purpose it proposes a method for obtaining a succession of images in the form of a sequence representing a circling effect substantially around an object of interest, in which:
a) a plurality of video cameras is provided arranged substantially in line to capture in their field, at different respective shot angles, a substantially fixed scene in which the said object of interest is likely to move,
b) different images acquired by the video cameras and representing the object of interest are gathered, and
c) a sequence is constructed by concatenation of the said images with an order of the said images in the sequence corresponding to an order of positions of the video cameras along the said line.

According to one aspect of the invention:
the said video cameras are fixed in position and in adjustment, and acquire the shots of the object of interest, in wide field including predetermined markers on the scene,
at step b), the images are readjusted in respective positions relative to one another, with the aid of the said predetermined markers on the scene.

It should be noted that one of the inventors of the present application proposed, in document U.S. Pat. No. 6,606,422, the use of a fixed wide field video camera, preferably of high definition (relative to a display member), in order to:
identify, in the current image that this video camera delivers, a zone of interest with the aid of predetermined markers, and
apply the replacement of at least a part of this zone by a chosen image, such as a publicity logo or other.

Thus, the simulation of a movement of the video camera could be achieved by performing a digital zoom in a region of the image encompassing the predetermined markers and by causing the zone of interest to move from one zoomed image to the other.

This technique, described in U.S. Pat. No. 6,606,422 and called “warping” based on a fixed video camera, is preferably used and suitable for implementing the method according to the invention.

Thus, in a preferred embodiment, on the acquired images, a zoom effect is applied to a zone surrounding the object of interest and defined by its dimensions including the shortest distance, amongst the acquired images, between the object of interest and an image edge.

This embodiment proves advantageous when the object of interest is close to an edge of the aforementioned scene, for at least one of the video cameras, as will be seen hereinafter in the detailed description with reference to the drawings.

The present invention also has as its subject an image processing device comprising:
inputs for receiving signals of images emanating from a plurality of digital video cameras,
memory means suitable for successively storing the said signals of images, and
a unit for processing the said signals.

In particular, the processor unit comprises a memory capable of storing a computer program product which then comprises instructions for carrying out some or all of the steps of the method according to the invention.

Accordingly, the present invention also has as its subject such a computer program product intended to be stored in a memory of a processor unit of the aforementioned type, or on a removable memory medium, and intended to interact with a drive of the said processor unit.

Other features and advantages of the invention will appear on examination of the detailed description hereinafter, and of the appended drawings in which:

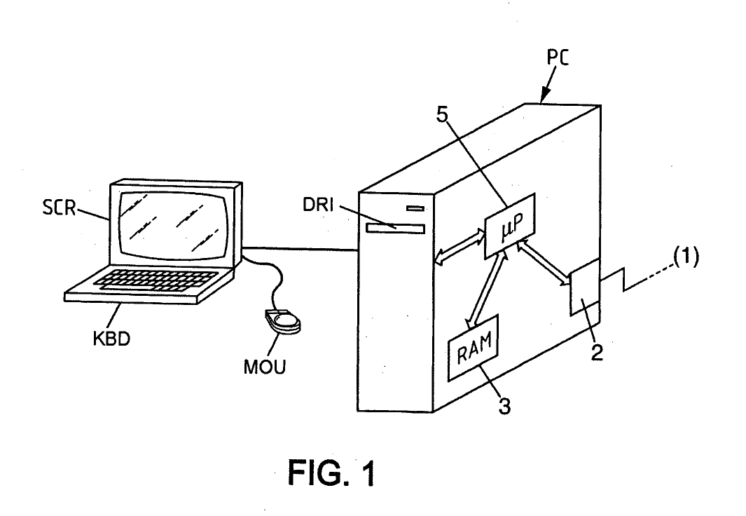

FIG. 1 represents schematically a computer device for implementing the method according to the invention,

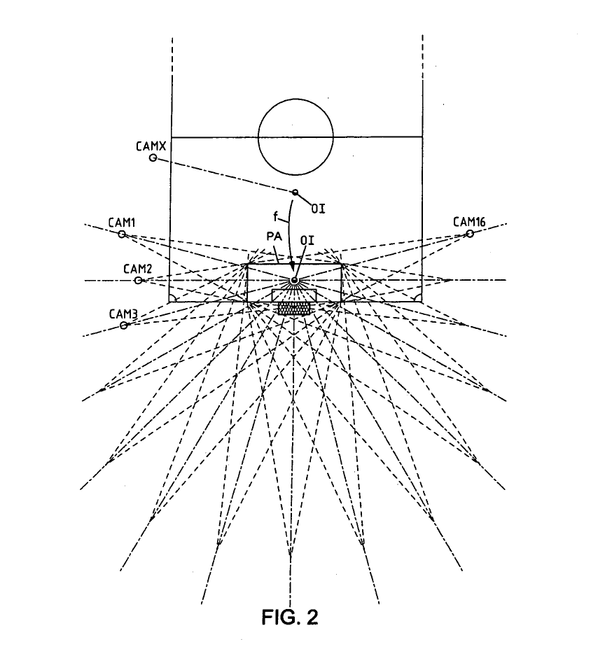

FIG. 2 illustrates schematically the fixed disposition of the video cameras relative to the object of interest, which is likely to be mobile,

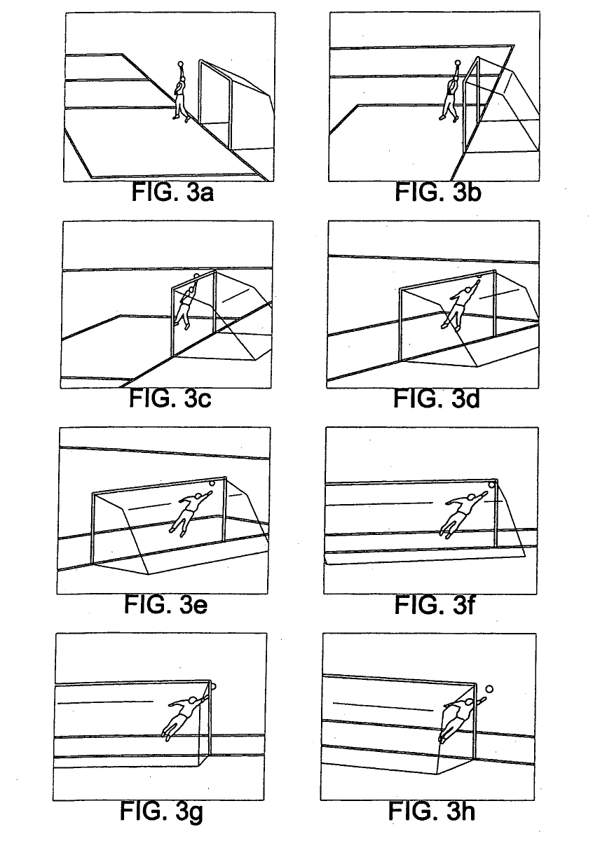

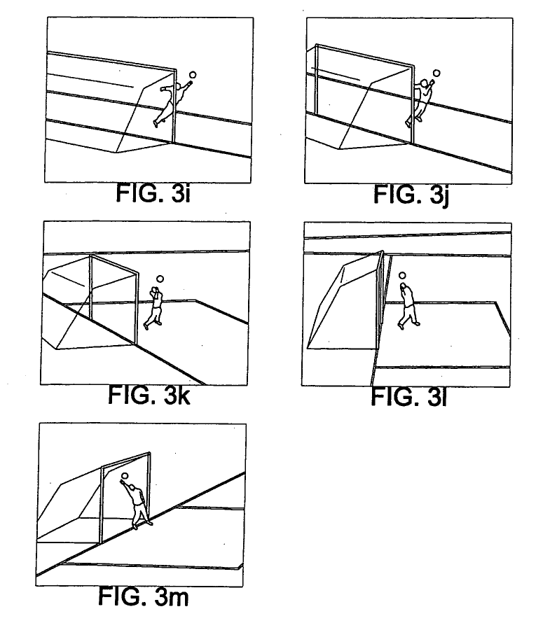

FIGS. 3a to 3m illustrate at least a part of the images acquired and zoomed in on by implementing the method according to an advantageous embodiment of the invention, for a sporting event,

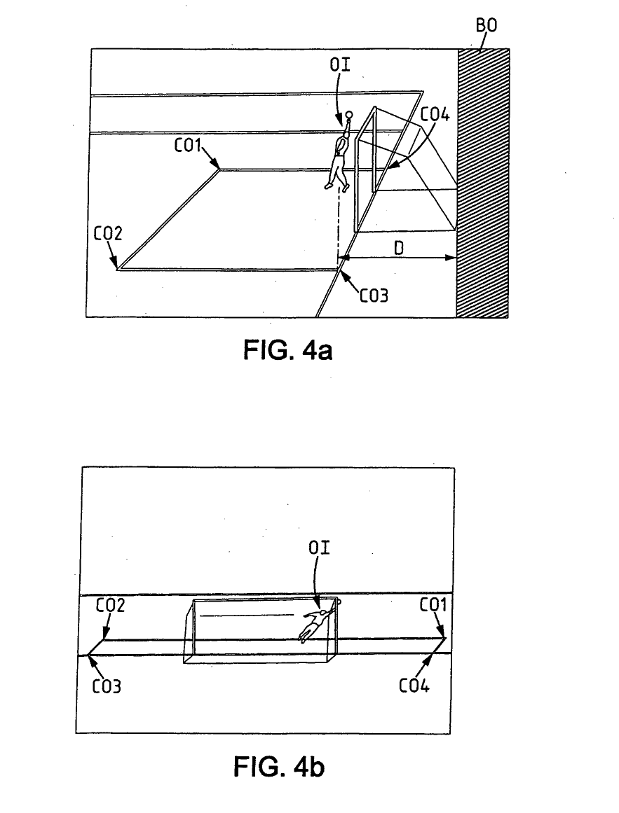

FIGS. 4a and 4b represent raw and unzoomed images corresponding respectively to the aforementioned FIGS. 3b and 3g, and

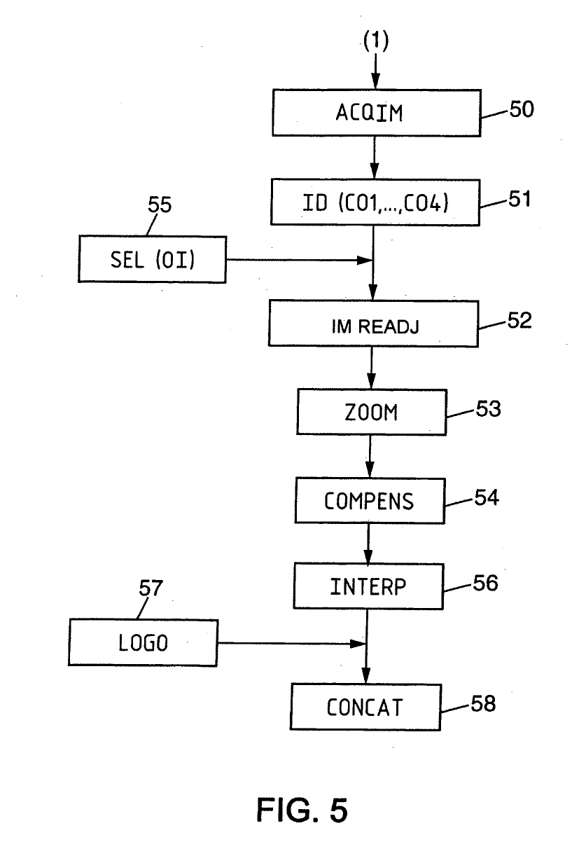

FIG. 5 represents a flow chart summarizing the main steps for processing the acquired images, according to a particular embodiment of the invention.

Reference is made first of all to FIG. 1 which represents schematically a computer processor unit for implementing the method according to the invention. The processor unit PC comprises an interface 2 comprising inputs for receiving signals of images 1 emanating from a plurality of digital video cameras. It also comprises memory means 3, for example a random access memory RAM, capable of successively storing these signals of images. In addition, a memory medium is provided capable of storing a computer program product which comprises instructions for the implementation of some or all of the steps of the method according to the invention. For example, the computer program may be stored in a removable memory medium such as a CD-ROM capable of interacting with a counterpart drive. DRI that the processor unit PC comprises, or else a USB key. As a variant, it may be stored in a memory, for example of the ROM type, of the processor unit PC. In another variant, this program may be downloaded from a remote site thanks to a communication interface (not shown) that the processor unit may comprise.

In the example shown in FIG. 1, a processor 5 interacts with all the elements previously described, to control the interactions between these elements. The processor unit also comprises a display monitor SCR, and one or more input members such as a keyboard KBD and a mouse MOU.

FIG. 2 shows a plurality of video cameras CAM1 to CAM16 which deliver the aforementioned signals of digital images 1. In the example shown, the scene to be filmed comprises a penalty area PA of a football pitch. Preferably, approximately sixteen fixed video cameras CAM1 to CAM16 are provided in this application. These cameras are distributed around the penalty area, substantially in line (for example on an arc of a circle or of an ellipse) to capture in their field, at different respective shot angles, a fixed scene comprising the penalty area PA, in which an object of interest OI is likely to move, such as one of the players on the pitch. It is indicated that the line on which the video cameras are disposed may be curved or straight, the main thing being that the respective shot angles of the video cameras are different.

Note that the video cameras are fixed in position and in adjustment, and acquire the shots of the player OI, in wide field including predetermined markers on the scene. Typically, these predetermined markers may be characteristic points of the scene contrasting with a background of the scene and marked by recognition of shape or colour. For example, they may be the four corners of the penalty area delimited by a line that is substantially white relative to the green of the grass of the pitch. In the case of a retransmission of a game of tennis, the corners of the base line of the court may naturally be used, for example.

In a variant, the predetermined markers are given by a pattern arranged initially on the scene, for example on the pitch before the beginning of the game and of the retransmission, since the video cameras are fixed, particularly between the pattern sighting operation and the acquisition of the images of the object of interest.

Advantageously, the video cameras are arranged to take wide angle shots so as to cover, together, the largest possible dimensions of the scene including the penalty area. Furthermore, the video cameras are chosen to be of high definition. This measure is advantageous when it is preferable to zoom in on the acquired images, as will be seen hereinafter. In this case, the after-zoom sequence may be substantially of simple definition if the initial images were of high definition.

Those skilled in the art may refer to document U.S. Pat. No. 6,606,422 for further details on the monitoring of an object of interest or of a zone of interest in an image in wide field, thanks to predetermined markers.

It is indicated simply here that the video images are acquired in the form of a matrix of pixels, from the signals 1 originating from the fixed wide field and high definition cameras (for example, according to the HDTV standard, 1920×1080 pixels or more) usually greater than that of a display member, such as a standard television or the display monitor SCR of FIG. 1. Then a selection is made dynamically, in the field of the camera, of a format zone corresponding to that of the display member (typically 720×576 pixels in Europe on the Pal or Secam system or else 720×486 pixels in the United States of America, on the NTSC system) and including the object of interest OI. Then, by interpolation, from the pixels in the common zone selected from the images supplied by the video cameras, the pixels of an image of the size and definition of the display member are interpolated. For this purpose, preference may be given to applying a digital zoom on the images acquired by the fixed video cameras.

This digital zoom step may be justified as follows. In the example described here, the penalty area PA has been chosen as the scene including predetermined markers such as characteristic points. In this example, the video cameras must include in their field the corners of the penalty area corresponding to the aforementioned characteristic points. It will be understood however that the penalty area is of a size much greater than the normal size of a player, while this player may represent the object of interest around which it is desired to apply the circling effect. The result is that the player of interest appears to be very small in size on the raw image acquired. For this first reason, it may be preferred to apply a digital zoom on a zone surrounding the player of interest in the acquired images.

Furthermore, the player to whom it is desired to apply the circling effect may be placed close to an edge of the scene in the image acquired by a video camera. In this case, the player appears off-centre in the image. It may be advantageous to apply a digital zoom in a zone surrounding the player of interest in this image, to substantially recentre this zoomed image around the player of interest.

To explain the foregoing through drawings, FIGS. 3a to 3m show a part of the images acquired by the video cameras of FIG. 2 and then zoomed in on. Also shown, on FIGS. 4a and 4b, are the raw images, before the zooming step, corresponding to FIGS. 3b and 3g.

Here, the player of interest is a goalkeeper making a save. It is preferred in this example to select the six yard area as the scene and the corners of this area as the characteristic points. It is also indicated that the characteristic points may be selected dynamically from one implementation of the method to another, for example in the control room.

It can already be seen that the succession of images of FIGS. 3a to 3m produces the visual effect corresponding to the aforementioned circling effect.

FIGS. 4a and 4b comprise, as indicated hereinabove, the four characteristic points CO1 to CO4 corresponding to the corners of the six yard area in which the goalkeeper OI here moves. It is indicated however that one or more of the characteristic points may be lost in an image acquired by a video camera or, in other words, may “leave” the field of this video camera. In this case, the method of the invention, according to an advantageous embodiment, provides for a step consisting in relocating the position of the missing characteristic points by using a contrast line other than the six yard line, for example based on the line of the penalty area. It will be understood that, here again, use is made of a recognition of shapes in the acquired image.

In FIG. 4b, note that the object of interest OI appears to be of small size in the image. It will be understood that a digital zoom is preferably applied in a zone around the player OI.

In addition, in FIG. 4a, the player OI appears close to one edge of the scene. To readjust the images acquired by the respective video cameras together, the aim is preferably to substantially recentre the images relative to one another. Here, the aim is typically to recentre the image corresponding to FIG. 4a substantially around the player OI. However, if this recentering is brought onto the acquired raw image (from left to right in the example shown in FIG. 4a), a black band BO bordering the image may quite simply appear in certain image processing systems.

Thus it will be understood that the distance D from the object of interest OI to an image edge BO may define the level of digital zoom that is applied.

Naturally, in order not to create leaps of scale from one image to the next, equivalent zooms are applied to consecutive images.

In short, in a preferred embodiment, a zoom is made on the acquired images of a zone surrounding the object of interest and defined by its dimensions including the shortest distance D, amongst the acquired images, between the object of interest OI and an image edge BO.

Again with reference to FIG. 2, also shown is an additional video camera CAMX, mobile in position and/or in adjustment, therefore capable of following the movements of the object of interest OI. This video camera CAMX may acquire a first series of images, for example of the player OI whose movement is represented by the arrow f in FIG. 2.

Advantageously, it is possible to construct a sequence by concatenation of this first series of images with the images respectively acquired by the fixed video cameras CAM1 to CAM16. Preferably the procedure is to readjust the last image or images acquired by the mobile video camera with the images acquired by the fixed video cameras.

Reference is now made to FIG. 5 to summarize the main steps of processing the acquired images, according to an advantageous embodiment of the invention.

In step 50, various images acquired in wide field by the fixed video cameras and representing the object of interest OI in a scene including the predetermined markers CO1 to CO4 have been retrieved in the form of the aforementioned signals 1. It is indicated that, at the same time, the video cameras acquire respective successions of images, and preferably a single image per video camera is isolated to construct a circling effect sequence.

In step 51, as indicated hereinabove, the predetermined markers CO1 to CO4 are identified on the acquired images to carry out, in step 52, a readjustment of the images in respective positions relative to one another, with the aid of the predetermined markers CO1 to CO4 on the scene.

However, to readjust these images substantially around the object of interest, the procedure is, in step 55, to select, for example manually, the object of interest OI in at least one of the acquired images (the selection of the object of interest in the following images being able to be carried out automatically thereafter, for example by shape recognition). Thus, subsequent to the acquisition of the images, an object of interest OI to be followed in the acquired images is selected. Accordingly, an operator may use an input member such as the mouse (MOU) of the processor unit PC to select the object of interest OI.

These steps may be carried out typically in the control room, for example during a substantially live audiovisual broadcast. The images processed in the control room are then broadcast with a slight time delay, as sequences called “slow motion” showing an action replay.

It is possible to choose to construct the sequence of images representing the circling effect from images acquired substantially at the same time by the video cameras CAM1 to CAM16, or, in a variant, from images acquired with a chosen time delay from one image to another and increasing according to a video camera order in the line formed by the respective positions of the video cameras CAM1 to CAM16.

When the images have been readjusted relative to one another, preferably the digital zoom step 53 described hereinabove is applied, particularly to avoid the appearance of image edges BO.

In step 54, it is preferable to provide for a compensation for a difference of luminosity and/or colorimetry between the different acquired images, in a manner known per se.

Provision may also be made for a step 56 of interpolation between the acquired images in order to produce a substantially fluid sequence. For example, a technique called “morphing” may be used for this purpose.

Advantageously, a step 57 may also be provided for virtual insertion of a logo (for example a publicity logo) or an additional image in some or all of the acquired images. Such an insertion is described in particular in the aforementioned document U.S. Pat. No. 6,606,422. It is simply indicated here that this step typically comprises a definition of the position of the additional logo or image, as a function of the predetermined markers CO1 to CO4 on the scene.

Finally, in step 58, the circling effect sequence proper is constructed, by concatenating the images thus processed with an order of these images in the sequence that corresponds to an order of the positions of the video cameras along the aforementioned line.

Naturally, the present invention is not restricted to the embodiment described hereinabove as an example; it extends to other variants.

For example, the retransmitted sporting event may be different from a football match. In this case, the number of video cameras may be other than sixteen as described hereinabove and they may be disposed other than in an arc of a circle or an ellipse (for example on a straight line for a horse race or other type of race), and the number of chosen characteristic points may be other than four as described hereinabove.

1. Method for obtaining a succession of images in the form of a sequence representing a circling effect substantially around an object of interest, in which:
a) a plurality of video cameras are provided arranged substantially in line to capture in their field, at different respective shot angles, a substantially fixed scene in which an object of interest is likely to move,
b) different images acquired by the video cameras and representing the object of interest are gathered, and
c) a sequence is constructed by concatenation of said images with an order of said images in the sequence corresponding to an order of positions of the video cameras along said line, wherein:
said video cameras are fixed in position and in adjustment, and acquire the shots of the object of interest, in wide field including predetermined markers on the scene,
at step b), the images are readjusted in respective positions relative to one another, with the aid of said predetermined markers on the scene.

2. Method according to claim 1, wherein, on said acquired images, a zoom effect is applied to a zone surrounding the object of interest and defined by its dimensions including the shortest distance, amongst the acquired images, between the object of interest and an image edge.

3. Method according to claim 2, wherein the video cameras are chosen to be of high definition to obtain an after-zoom sequence substantially of simple definition.

4. Method according to claim 1, wherein it comprises a step of compensation for a difference of luminosity/colorimetry between the different acquired images.

5. Method according to claim 1 wherein it comprises a step, subsequent to the acquisition of the images, of selecting an object of interest to be followed in said acquired images.

6. Method according to claim 1, wherein said video cameras are arranged to take wide angle shots so as to cover, together, the largest possible dimensions of the scene.

7. Method according to claim 1, wherein said predetermined markers are characteristic points of the scene contrasting with a background of the scene.

8. Method according to claim 1, wherein said predetermined markers are given by a pattern arranged initially on said scene, the video cameras being fixed between the operation of pattern aiming and the acquisition of the images of the object of interest.

9. Method according to claim 1, wherein it comprises a step of interpolation between the acquired images in order to produce a substantially fluid sequence.

10. Method according to claim 1, wherein it also comprises a step of virtual insertion of a logo or of an image in some or all of the acquired images, with the position of the logo or of the image being defined as a function of said predetermined markers on the scene.

11. Method according to claim 1, wherein an additional video camera, mobile in position and/or in adjustment, is also provided capable of following movements of the object of interest to acquire a first series of images, and wherein a sequence is constructed by a concatenation of said first series with the images acquired by said fixed video cameras, with readjustment of at least a part of the images of the first series and of the images acquired by the fixed video cameras.

12. Method according to claim 1, wherein, the video cameras acquire respective successions of images, at the same time; and wherein a single image per video camera is isolated to construct a sequence.

13. Method according to claim 12, wherein the image sequence is constructed from images acquired substantially at the same time by said video cameras.

14. Method according to claim 12, wherein the image sequence is constructed from images acquired with a chosen time difference from one image to another and increasing according to a video camera order in said line.

15. Method according to claim 1, wherein the scene comprises a penalty area of a football pitch, and in that approximately sixteen fixed video cameras are provided.

16. Method according to claim 1, wherein said images are intended for substantially live audiovisual broadcasting, and wherein said sequence is broadcast with a slight time delay.

17. Computer program product, intended to be stored in a memory of a processor unit, or on a removable memory medium, and intended to interact with a drive of said processor unit, characterized in that it comprises instructions for carrying out steps of a method for obtaining a succession of images in the form of a sequence representing a circling effect substantially around an object of interest, in which:
a) a plurality of video cameras are provided arranged substantially in line to capture in their field, at different respective shot angles, a substantially fixed scene in which an object of interest is likely to move,
b) different images acquired by the video cameras and representing the object of interest are gathered, and
c) the computer program product comprising instructions for constructing a sequence by concatenation of said images with an order of said images in the sequence corresponding to an order of positions of the video cameras along said line;
and wherein:
said video cameras are fixed in position and in adjustment, and acquire the shots of the object of interest, in wide field including predetermined markers on the scene,
for performing step b), the computer program product comprises instructions for readjusting the images in respective positions relative to one another, with the aid of said predetermined markers on the scene.

18. Image processing device, comprising:
inputs for receiving signals of images emanating from a plurality of digital video cameras,
memory means suitable for successively storing thesaid signals of images, and
a unit for processing said signals, wherein said processor unit comprises a memory capable of storing a computer program product comprising instructions for carrying out steps of a method for obtaining a succession of images in the form of a sequence representing a circling effect substantially around an object of interest, in which:
a) a plurality of video camera are provided arranged substantially in line to capture in their field, at different respective shot angles, a substantially fixed scene in which an object of interest is likely to move,
b) different images acquired by the video cameras and representing the object of interest are gathered, and
c) the computer program product comprising instructions for constructing a sequence by concatenation of said images with an order of said images in the sequence corresponding to an order of positions of the video cameras along said line;
wherein:
said video cameras are fixed in position and in adjustment, and acquire the shots of the object of interest, in wide field including predetermined markers on the scene,
for performing step b), the computer program product comprises instructions for readjusting the images in respective positions relative to one another, with the aid of said predetermined markers on the scene.

19. Device according to claim 18, wherein it comprises an input member suitable for interacting with the processor unit to select an object of interest to be followed in said acquired images.
